(19) United States
(12) Patent Application Publication
(10) Pub. No.: US 2005/0272004 A1
(43) Pub. Date: Dec. 8, 2005

(54) Non-landed endodontic instrument and methods of making such endodontic instruments

(75) Inventor: John Joseph Desrosiers, Manhattan Beach, CA (US)

Correspondence Address: WOOD, HERRON & EVANS, LLP, 2700 CAREW TOWER, 441 VINE STREET, CINCINNATI, OH, 45202, US

(73) Assignee: Ormco Corporation, Orange, CA (US)

(21) Appl. No.: 10/863,451

(22) Filed: Jun. 8, 2004

(51) Int. Cl. A61C 5/02

(52) U.S. Cl. 433/102

(57) ABSTRACT

Endodontic instruments, including files, reamers, and condensers, that lack margins or radial lands. The instruments include at least one edge that does not provide significant tissue-cutting action and at least one cutting edge. The elimination of margins or radial lands reduces the surface area over which the root canal wall is contacted by the working length of the instrument.

### FIELD OF THE INVENTION

The invention relates generally to dental instruments and, more particularly, relates to endodontic instruments for extirpating pulp tissue and dentin from a root canal before obturating the root canal.

### BACKGROUND OF THE INVENTION

Successful root canal therapy effectively alleviates the pain and trauma originating from the decayed, damaged or dead circulatory and neural pulp tissue so that the tooth need not be extracted. After the pulp chamber, and subsequently the coronal root canal orifice(s), have been accessed during a root canal procedure, pulp tissue is extirpated from the root canal(s) of the tooth. Some surrounding dentin is also removed in the shaping of the root canal(s). After the root canal(s) have been sufficiently shaped and cleaned, sealant and obturation materials are used to fill and seal the root canal(s). To conclude the procedure, the access cavity in the coronal portion of the tooth is sealed using a restorative procedure to prevent future infection and decay.

Various endodontic instruments are employed to remove the pulp tissue and dentin from the root canal and to enlarge and shape the root canal in preparation for obturation. Conventional endodontic reamers or files employed for extirpation during root canal therapy generally include a thin, flexible, metal shaft with an abrasive surface or sharp edges, which promotes efficient cleaning of the root canal. A shank at one end of the endodontic file is adapted for gripping by a dentist or attachment to a mechanical device such as a dental drill. Obturation material may be packed into the prepared root canal using similar endodontic instruments. Endodontic files are normally rotated and moved into and out of the root canal along the instrument's longitudinal axis.

Endodontic files may be categorized generally as either non-landed or landed. Non-landed endodontic files typically have a working length that features three or more sides and a non-aggressive scraping edge of extremely negative rake angle at the intersection between each side pair. Although non-landed files are relatively simple to manufacture, the instrument tends to inefficiently push or scrape pulp tissue within the root canal wall rather than cutting the tissue. This inefficient scraping action applies additional stress to the instrument, which increases the incidence of instrument fracture and breakage. Another deficiency of non-landed files is that excised pulp tissue may be transported apically and packed into the canal apex, instead of being carried in a coronal direction and removed from the root canal.

Landed endodontic files, on the other hand, have a working length that includes at least one tissue-removing edge defined by a lengthwise flute and one or more curved radial lands (sometimes referred to as “margins”). Given a cross-section taken perpendicular to the longitudinal axis, all points of each land are on the outer periphery of the file and are equidistant radially from the file's longitudinal rotational axis. Landed endodontic files are typically more difficult and costly to manufacture than non-landed endodontic files because of the process of forming lands and flutes. However, landed endodontic files may cut pulp tissue more efficiently than non-landed files, particularly if the tissue-removing edge has a positive rake angle. In addition, the flutes provide pathways along the instrument working length for the efficient capture and transport of excised pulp tissue in a coronal direction out of the root canal. The working lengths of landed endodontic files tend to have a larger cross-sectional area than the working lengths of non-landed endodontic files. As the instrument is rotated in a curved canal, the greater cross-sectional area causes greater cyclic fatigue, which may increase the propensity for fracture.

The radial lands on landed endodontic files represent bearing surfaces that, when the instrument is rotated in the root canal, contact and rub against the canal wall. The friction from the sliding contact is dissipated as heat, which induces stresses in the instrument and may lead to unexpected fracture. In addition to a diminished product lifetime and interruptions during root canal therapy to replace broken instruments, an instrument fracture may result in patient discomfort and an undesirable final shape. In extreme cases an instrument fragment that cannot be retrieved may lead to infection and ultimately tooth extraction.

Thus, there would be a need for an endodontic instrument that overcomes these deficiencies of conventional landed and non-landed endodontic files.

### SUMMARY OF THE INVENTION

The invention overcomes the foregoing and other shortcomings and drawbacks of conventional endodontic instruments, as described above. According to the principles of the invention, an apparatus which may be an endodontic instrument in certain embodiments, includes an elongated shaft having a longitudinal axis, a working length extending along the longitudinal axis, and a plurality of longitudinal regions arranged about the longitudinal axis. A plurality of edges extends longitudinally along the working length. Each of the edges is distanced radially from the longitudinal axis, and adjacent pairs of the edges are adjoined or joined along the working length by a corresponding one of the regions. At least one of the edges has a rake angle more negative than about −30° and at least one of the edges has a rake angle equal to or more positive than 0°. At any axial location along the working length, a cross-section may be taken perpendicular to the longitudinal axis. Each of the edges defines a maximum radius, which is measured at the axial location perpendicular to the longitudinal axis. The regions are positioned radially inside an imaginary circle centered about the longitudinal axis at the axial location and having a radius measured perpendicular to the longitudinal axis equal to the maximum radius. The edges are arranged such that each void area, bounded by each respective region and the imaginary circle, is less than half the total area of the imaginary circle.

Endodontic instruments of the invention improve upon conventional endodontic instruments as the positive attributes of landed instrument types and the positive attributes of non-landed instrument types are both present, while their significant negative attributes are either eliminated or reduced. The endodontic instruments feature a plurality of longitudinally-extending surfaces in the form of facets and curved surfaces arranged in a substantially polygonal or ovoidal cross-sectional profile and at least one longitudinally-extending flute defining an edge having a rake angle equal to or more positive than 0°. Adjacent facets meet at an edge having a rake angle more negative than about −30°. Likewise, the ovoidal longitudinally-extending surfaces leave an outermost edge having a rake angle more negative than about −30°. The endodontic instruments of the invention lack radial lands or margins between adjacent edges so that the only points of contact with the canal wall are the edges. In other words, the periphery of the inventive endodontic instruments lacks arcs of constant radius, measured relative to the instrument centerline, that lie on the surface of revolution, as defined elsewhere herein.

The above and other objects and advantages of the invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a side view of an endodontic instrument according to the invention.

FIG. 2 is a perspective view of the endodontic instrument of FIG. 1 with the tip absent for clarity.

FIG. 3 is a cross-sectional view taken generally along line 3-3 in FIG. 2.

FIG. 3A is an enlarged view of a portion of FIG. 3.

FIGS. 4A and 4B are cross-sectional views similar to FIG. 3 at stages in the fabrication of the endodontic instrument preceding the fabrication stage of FIG. 3.

FIGS. 5A-G are cross-sectional views similar to FIG. 3 of endodontic instruments in accordance with alternative embodiments of the invention.

FIG. 6 is a side view of an endodontic instrument similar to the endodontic instrument of FIG. 1 in accordance with an alternative embodiment of the invention.

FIG. 7 is a side view of an endodontic instrument in accordance with an alternative embodiment of the invention.

FIGS. 7A and 7B are cross-sectional views taken generally along line 7A-7A and line 7B-7B in FIG. 7.

FIGS. 8A and 8B are cross-sectional views similar to FIGS. 7A and 7B of an endodontic instrument in accordance with an alternative embodiment of the invention.

FIG. 9 is a side view of an endodontic instrument in accordance with an alternative embodiment of the invention.

FIGS. 9A and 9B are cross-sectional views taken generally along line 9A-9A and line 9B-9B in FIG. 9.

FIGS. 10A and 10B are cross-sectional views similar to FIGS. 9A and 9B of an endodontic instrument in accordance with an alternative embodiment of the invention.

FIG. 11 is a side view of an endodontic instrument in accordance with an alternative embodiment of the invention.

### DETAILED DESCRIPTION

The instruments of the invention may be used as reamers, files, or condensers. In all of the embodiments disclosed and described herein, the instruments are represented as reamers or files used for cleaning and shaping root canals or for creating a space for a post used to secure a crown or bridge. It will be appreciated by persons of ordinary skill in the art that the instruments described herein when provided with negative helix fluting may be used as condensers for pushing obturation materials, such as gutta percha, toward the canal apex for filling the root canal after it has been extirpated and shaped by reamers and files.

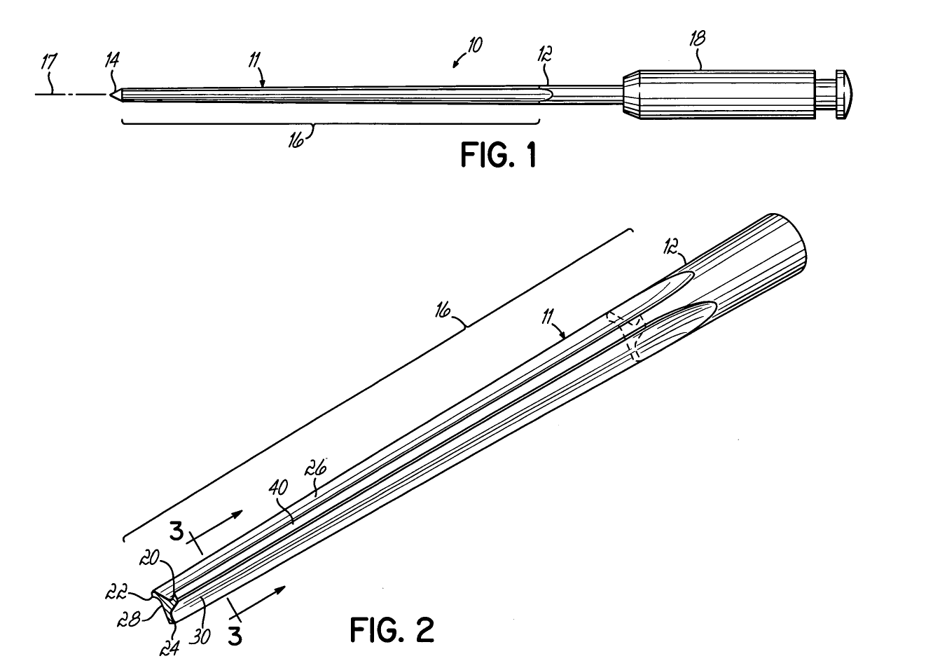

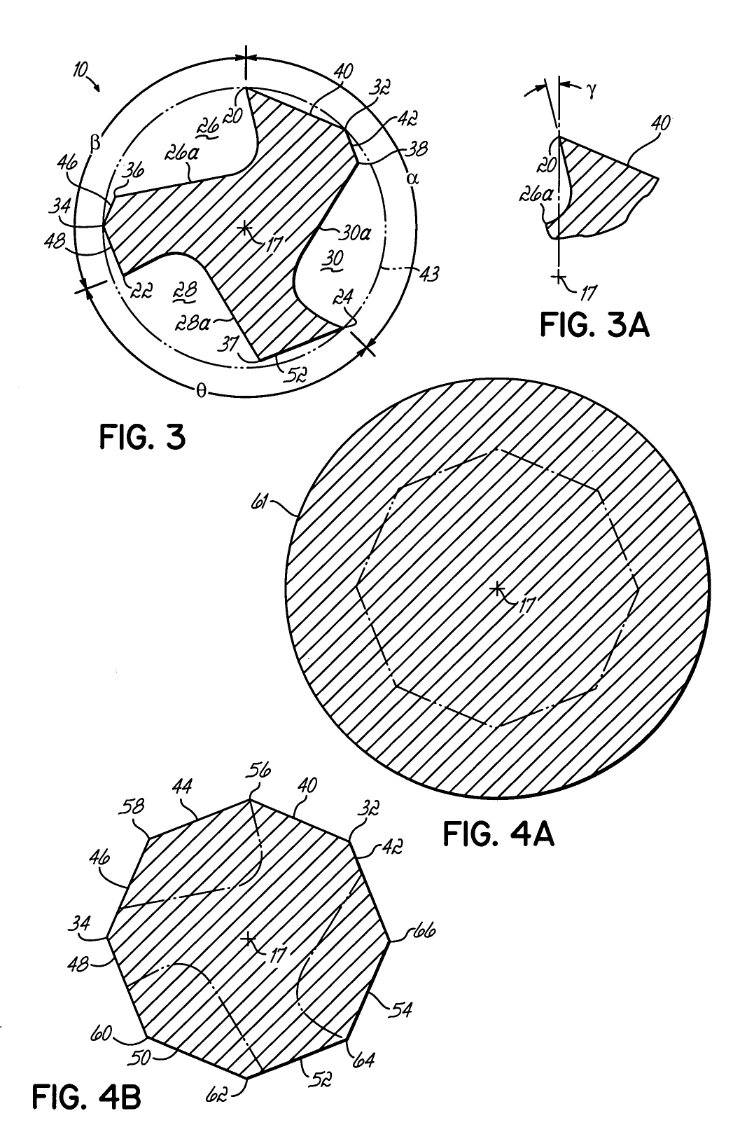

With reference to FIGS. 1 and 2, an endodontic instrument, generally indicated by reference numeral 10, includes a shaft 11 having a base or proximal end 12, a point or distal end 14, and an elongate working length 16 extending between ends 12 and 14 along a longitudinal shaft axis 17 generally aligned with the centerline of the shaft 11. A shank 18 situated at the proximal end 12 and adapted for interfacing or gripping instrument 10 with a chuck or collet of a motorized rotary dental handpiece or, alternatively, of manually manipulating the instrument 10 with a handgrip of some form. Manipulation of the instrument 10 in a cutting movement for extirpating pulp tissue and/or dentin under conventional circumstances includes rotating the instrument 10 about the shaft axis 17 and simultaneously reciprocating the instrument 10 longitudinally along the shaft axis 17.

The working length 16 of the instrument 10 is lengthwise tapered along axis 17 in a longitudinal direction between ends 12 and 14 with the diameter decreasing in a direction toward distal end 14. Alternatively, the working length 16 may have a uniform cross-sectional diameter or a zero taper, or may have a taper characterized by a slowly increasing diameter in a direction toward distal end 14. If tapered, the taper of the cross-sectional diameter of the working length 16 may range from about −0.02 millimeters per millimeter to about 0.2 millimeters per millimeter when measured from the distal end 14 to the proximal end 12. The length of the working length 16 may range, without limitation, from about 0.5 millimeter to about 20 millimeters. The overall length of the instrument 10 may range, without limitation, from about 10 millimeters to about 60 millimeters. The diameter of the distal end 14 may range, without limitation, from about 0.04 millimeter to about 1.5 millimeters.

With reference to FIGS. 2, 3 and 3A, extending lengthwise and linearly along the working length 16 of endodontic instrument 10 are a plurality of cutting edges 20, 22 and 24 each defined by one of a corresponding plurality of lengthwise-extending flutes 26, 28 and 30 and a plurality of guiding edges 32 and 34. The cutting edges 20, 22 and 24, the flutes 26, 28 and 30, and the guiding edges 32 and 34 are parallel, i.e., they extend along paths that do not intersect each other along the working length 16.

The cross-sectional profile at any location along the working length 16 is substantially identical and is shown best in FIGS. 2 and 3. Each of the flutes 26, 28 and 30 includes a concave surface 26a, 28a and 30a, respectively, constructed from two planar surfaces and a continuously curved surface joining the two planar surfaces. Each of the concave surfaces 26a, 28a and 30a is defined or inscribed as a lengthwise groove along the working length 16 and each extends between one of the cutting edges 20, 22 and 24 and a corresponding one of trailing edges 36, 37 and 38. The planar surface of each of concave surfaces 26a, 28a and 30a facing in the direction of rotation of the shaft 11, when rotating during use, constitutes a cutting face terminated by a corresponding one of the cutting edges 20, 22 and 24. The planar surface of each of concave surfaces 26a, 28a and 30a facing in a direction opposite to the rotation of the shaft 11, when rotating during use, constitutes a non-cutting face terminated by a corresponding one of the trailing edges 36, 37 and 38. Each of the flutes 26, 28 and 30 is characterized by a cross-sectional profile viewed from a perspective parallel to the shaft axis 17, a flute depth measured radially from the shaft axis 17 to the nearest point of the corresponding concave surface 26a, 28a and 30a, and a flute volume given by the product of the flute cross-sectional area and working length 16, assuming the flutes 26, 28 and 30 have a constant cross-sectional area along the working length 16.

With continued reference to FIGS. 2, 3 and 3A, guiding edge 32 is formed at the intersection of two longitudinally-extending surface portions or facets 40 and 42 that extend axially along the working length 16. At a given cross-section taken perpendicular to the shaft axis 17 anywhere along the working length 16, cutting edges 20 and 24 and guiding edges 32 and 34 lie on an imaginary circle 43 encircling the endodontic instrument 10. The cutting edges 20 and 24 and the guiding edges 32 and 34 define points on the imaginary circle 43. Along the entire working length 16, a surface of revolution is generated by the infinite series of imaginary circles defined by their respective cross-sections. Hence, this surface of revolution intersects the outermost radial points of the working length 16. The surface of revolution is cylindrical if the working length 16 has a zero taper or, if the working length 16 is tapered, the surface of revolution is frustoconical. Cutting edge 22 lies radially inside the imaginary circle 43 but, nonetheless, may provide a cutting action when the endodontic instrument 10 is rotated counterclockwise (as viewed in FIG. 3) about shaft axis 17 inside a root canal.

Flute 26 eliminates a former facet 44 (visible in FIG. 4B) and the trailing edge 36 of the concave surface 26a defining flute 26 effectively narrows the width of facet 46. Extending axially along the working length 16 is an additional facet 48 that intersects facet 46 at guiding edge 34. Flute 28 eliminates a former facet 50 (visible in FIG. 4B) and the cutting edge 22 of the concave surface 28a defining flute 28 effectively narrows the width of facet 48. Flute 28 also effectively narrows the width of facet 52. Concave surface 30a of flute 30 intersects the facet 52 for defining cutting edge 24 at a former location of guiding edge 64 (visible in FIG. 4B) and, due to the angle at which the curved surface 30a intersects the facet 52, transforms the former guiding edge into cutting edge 24. Flute 30 eliminates a former facet 54 (visible in FIG. 4B) and the trailing edge 38 of the concave surface 30a defining flute 30 effectively narrows the width of facet 42.

With continued reference to FIGS. 2, 3 and 3A, each of the cutting edges 20 and 24 lie on the imaginary circle 43, although the invention is not so limited as any or all the cutting edges 20, 22 and 24 may be positioned radially inside the imaginary circle 43. A distinct relief angle is defined between a line tangent to the imaginary circle 43 at each of the cutting edges 20, 22 and 24 and the corresponding adjacent one of the facets 40, 48 and 52. The relief provides clearance and prevents rubbing against the canal wall. Each of the guiding edges 32 and 34 lie on the imaginary circle 43. Trailing edges 36, 37 and 38 are positioned radially inside the imaginary circle 43 unless coincident spatially with a guiding edge. In the latter instance, the spatial coincidence does not transform a guiding edge to a cutting edge, regardless of the angle of intersection, as each of the trailing edges 36, 37 and 38 faces a direction counter to the direction of rotation of shaft 11 and, hence, provides no cutting action.

Each of the cutting edges 20, 22 and 24 and guiding edges 32 and 34 defines a radius measured perpendicular to the shaft axis 17 and determined at an arbitrary axial location along the working length 16. The set of radii ranges between a maximum radius and a minimum radius at any axial location. The facets 40, 42, 46, 48 and 52 and concave surfaces 26a, 28a and 30a define a plurality of longitudinal regions arranged about the shaft axis 17. Adjacent pairs of cutting edges 20 and 24 and guiding edges 32 and 34 at the maximum radius are adjoined or joined at any arbitrary axial location by a corresponding one of the regions, which extend about the contoured outer periphery of the working length 16. At any arbitrary axial location, these regions are positioned radially inside the imaginary circle 43, which has a radius measured relative to the longitudinal axis 17 equal to the maximum radius from among the set of radii. Each void area, or open space, is bounded by the intervening facets and concave surfaces between an adjacent pair of edges 20, 24, 32 and 34 and the arc of the imaginary circle lying between the edge pair.

Edges 20, 24, 32 and 34, and imaginary circle 43 are arranged, when viewed in cross section at any arbitrary axial location, such that a bounded void area is less than half of the total area of the imaginary circle 43. Stated differently, the void area defined by any single region cannot reduce the dynamic cross-sectional area of the working length 16 at any axial location along the working length 16 by more than 50 percent. For example, cutting edge 20 and guiding edge 34 are arranged such that the collective void area bounded between concave surface 26a and facet 46, which collectively represent the region between edges 20 and 34, and the imaginary surface 43 is less than half the total area of the imaginary circle 43. As another example, cutting edge 24 and guiding edge 34 are arranged such that the collective void area bounded between imaginary circle 43 and the surface defined by facet 48, concave surface 28a, and facet 52, which collectively represent the region between edges 24 and 34, is less than half the total area of the imaginary circle 43.

With reference to FIGS. 3 and 3A, each of the cutting edges 20, 22 and 24 is characterized by a positive rake angle, y, which is measured between a line defined by the respective cutting edge and shaft axis 17, and a line parallel to a corresponding one of concave surfaces 26a, 28a and 30a proximate to the associated one of the cutting edges 20, 22 and 24. In alternative embodiments of the invention, the rake angle of each of the cutting edges 20, 22 and 24 may be neutral. In other embodiments of the invention, the rake angle of one or more of the cutting edges 20, 22 and 24 is neutral. In yet other embodiments of the invention, the rake angle of one or more of the cutting edges 20, 22 and 24 is positive. In yet other embodiments of the invention, each of the cutting edges 20, 22 and 24 may be characterized without limitation by either a positive rake angle or a neutral rake angle.

The efficiency or the aggressiveness of the cutting action of each of the cutting edges 20, 22 and 24 generally increases as the rake angle is made more positive. Generally, rake angles equal to or more positive than 0° efficiently cut dentin and pulp tissue, with the cutting efficiency or aggressiveness increasing as the rake angle becomes more positive. The guiding edges 32 and 34, which are characterized by rake angles more negative than about °, provide some tissue scraping action, but are present primarily to guide the instrument 10 within the root canal.

With reference to FIG. 3, the concave surfaces 26a, 28a and 30a of the flutes 26, 28 and 30 are each constructed from two individual flat or planar surfaces and a continuously curved surface joining the two planar surfaces. Alternatively, one or more of the concave surfaces 26a, 28a and 30a may be formed from one or more flat or planar segments, one or more continuously curved surfaces, or any combination thereof. The depth of each flute 26, 28 and 30, which is measured radially outward from the shaft axis 17, is substantially equal. However, the invention contemplates that the flute depths may differ among the various flutes 26, 28 and 30. The flute volumes, which reflect the amount of material removed from the working length 16 to introduce the flutes 26, 28 and 30, are substantially equal, although the invention is not so limited. The flutes 26, 28 and 30 are each characterized by a substantially identical cross-sectional profile viewed parallel to the shaft axis 17. Alternatively, the cross-sectional profiles of some or all of the flutes 26, 28 and 30 may differ. The cutting edges 20, 22 and 24 are spaced about the circumference of the working length 16 at unequal angular intervals α, β, and θ that reflect curvilinear separations measured about the imaginary circle 43. The invention contemplates that, alternatively, either two or all of cutting edges 20, 22 and 24 may be spaced with equal or uniform angular intervals.

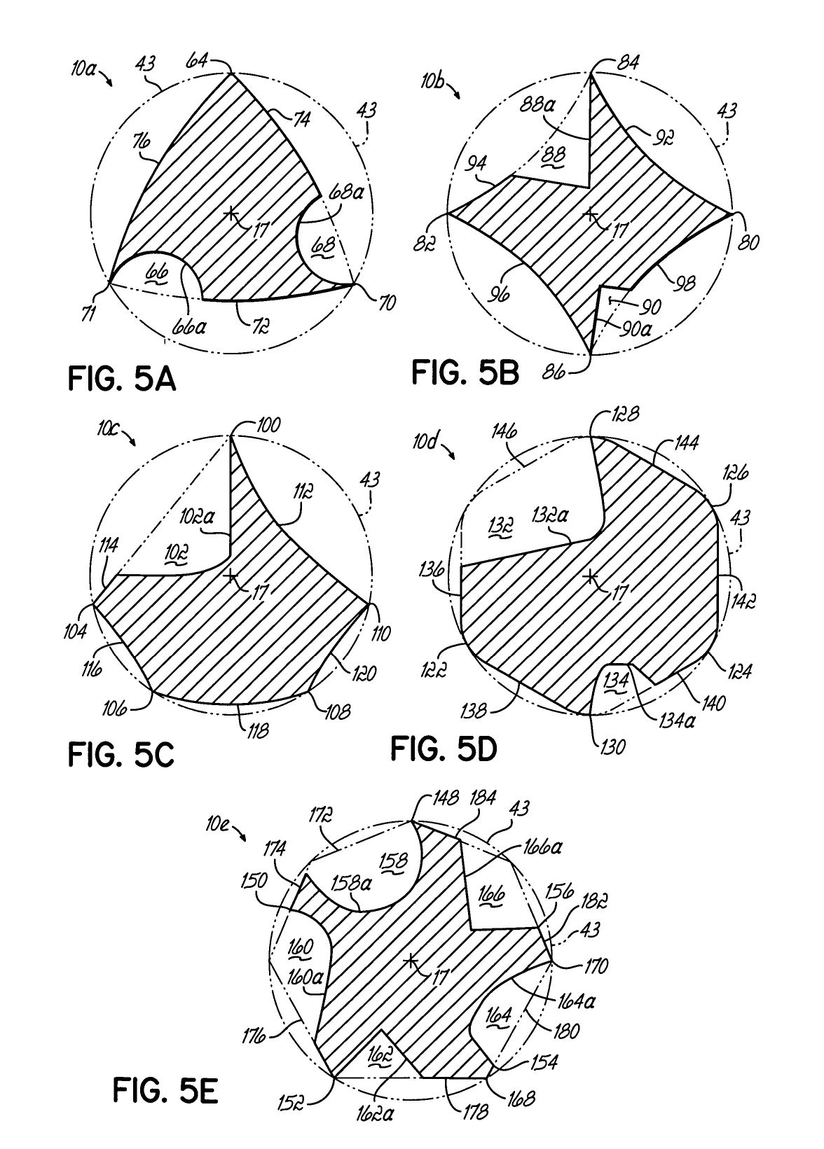

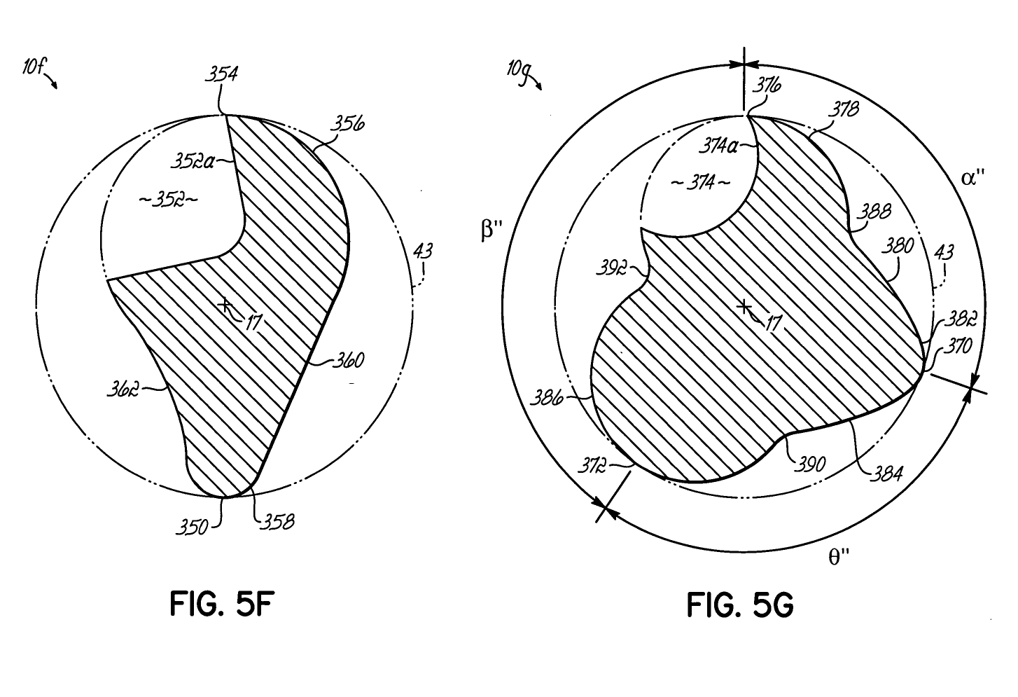

The properties of the facets 40, 42, 44, 46, 48, 50, 52 and 54 may be characterized as though the flutes 26, 28 and 30 were absent from endodontic instrument 10 for purposes of description. With this assumption in place, the facets 40, 42, 44, 46, 48, 50, 52 and 54 have a substantially octagonal arrangement and are substantially flat or planar, although the invention is not so limited as one or more of the facets 40, 42, 44, 46, 48, 50, 52 and 54 may be either slightly concave or slightly convex, so long as the convex shape is inscribed within the imaginary circle 43. Alternatively, some or all facets 40, 42, 44, 46, 48, 50, 52 and 54 may be replaced with any number of ovoidal longitudinally-extending surfaces provided the instrument maintains its non-landed properties as exemplified in FIGS. 5F and 5G. The facets 40, 42, 44, 46, 48, 50, 52 and 54 have equal widths. However, the invention contemplates that two or more of the facets 40, 42, 44, 46, 48, 50, 52 and 54 may have unequal widths. The cross-section profile of the facets 40, 42, 44, 46, 48, 50, 52 and 54 possesses mirror symmetry about eight orthogonal planes. In alternative embodiments of the invention, the cross-sectional profile of the facets 40, 42, 44, 46, 48, 50, 52 and 54 may have mirror symmetry about multiple planes, only a single plane or may lack mirror symmetry.

With continued reference to FIG. 3, the guiding edges 32 and 34 and the cutting edges 20, 22 and 24 are depicted as beveled or chamfered. However, the guiding edges 32 and 34 may alternatively be radiused or rounded, as shown for guiding edges 122, 124, and 126 (FIG. 5D), to provide a smoother contact for guiding and centering the instrument 10 within the root canal. In addition, cutting edges 20, 22, and 24 may be radiused or rounded, as shown for cutting edges 128 and 130 (FIG. 5D).

The curved surfaces of the flutes 26, 28 and 30 define pathways that efficiently transport excised pulp tissue and dentin in a coronal direction toward the proximal end 12 and out of the root canal as the endodontic instrument 10 is rotated in the root canal, which represents one benefit of conventional landed endodontic instruments. The efficient removal of the excised pulp tissue and dentin reduces the friction acting on the working length 16, which reduces the likelihood of fracture or breakage as torque is applied to the instrument 10. The efficient coronal transport also reduces or eliminates transport of the excised pulp tissue and dentin toward the canal apex, which is a positive attribute or benefit characteristic of conventional landed endodontic instruments. The guiding edges 32 and 34 make a minor scraping contribution to the cutting action of the instrument 10, which is provided substantially exclusively by the operation of the cutting edges 20, 22 and 24. In contrast, the guiding edges 32 and 34 are designed to help guide and center the instrument 10 within the root canal.

With reference to FIGS. 3, 4A and 4B, methods of manufacturing the instruments 10 of the invention are illustrated. An initial workpiece 61, which is constituted by a single piece of a suitable material, is modified by the addition of longitudinally-extending surfaces in the form of facets 40, 42, 44, 46, 48, 50, 52 and 54 about its circumference. Though depicted as cylindrical for the purposes of example, the invention contemplates that workpiece 61 may initially be any shape or size without limitation. Although eight facets are illustrated in a geometrical shape representative of FIGS. 4A and 4B, it is understood by persons of ordinary skill in the art that three or more facets are formed with a substantially polygonal arrangement in the blank as reflected in FIGS. 3 and 5A-E. Although the facets 40, 42, 44, 46, 48, 50, 52 and 54 are depicted as planar, the invention contemplates that these surfaces may be planar, slightly concave, slightly convex or ovoidal. In cross-section, the polygonal arrangement of the facets 40, 42, 44, 46, 48, 50, 52 and 54 defines a boundary of a closed plane figure, which is octagonal. However, the invention admits to other multi-sided closed plane figures for the polygon arrangement including but not limited to triangular, quadrilateral, pentagonal, hexagonal, and heptagonal arrangements. The closed plane figure has multiple included angles formed at the intersection of each pair of constituent straight lines and/or curves. However, the invention contemplates that any one or more pairs of intersecting lines or curves in the cross-sectional profile may join at a rounded juncture, as illustrated for example in FIGS. 5D, 5F and 5G.

Then, flutes 26, 28 and 30 are added to the instrument 10 to define cutting edges. The addition of flutes 26, 28 and 30 shorten the width of certain facets and eliminate other facets in their entirety. In the illustrated embodiment, guiding edge 56 at the intersection of facets 40 and 44 and guiding edge 64 at the intersection of facets 52 and 54 are transformed into cutting edges 20 and 24, respectively, by the addition of the flutes 26 and 30. Guiding edge 58 at the intersection of facets 44 and 46, guiding edge 60 at the intersection of facets 48 and 50, guiding edge 62 at the intersection of facets 50 and 52, and guiding edge 66 at the intersection of facets 42 and 54 are removed from the blank by the addition of the flutes 26, 28 and 30. Facets 42, 46, 48 and 52 are narrowed by the addition of flutes 26, 28 and 30.

With continued reference to FIGS. 3, 4A and 4B, facets 40, 42, 46, 48 and 52 provide regions of clearance or relief that do not contact the canal wall during use. In particular, the facets 40, 42, 46, 48 and 52 do not subtend an arc of a single radius along the imaginary circle 43 over which contact exists between the working length 16 and the root canal wall, which contrasts with the significant contact between radial lands or margins with the root canal wall observed in conventional landed endodontic instruments. Instead, the facets 40, 42, 46, 48 and 52 are relieved to provide clearance with the root canal wall. Two guiding edges 32 and 34 remain after the flutes 26, 28 and 30 are added, although the invention is not so limited as at least one guiding edge should remain intact after an arbitrary number of flutes are added. In alternative embodiments, the flutes 26, 28 and 30 may be formed before the facets 40, 42, 44, 46, 48, 50, 52 and 54 are added so that the manufacturing stage of FIG. 4B transpires before the manufacturing stage of FIG. 4A, or all of the aforementioned features may be formed concurrently.

The initial workpiece 61 is composed of any material having a flexibility adequate to follow the curved path defined by the non-circular root canal without ledging or perforating the canal wall and sufficient strength for cutting and removing pulp tissue without fracture. Suitable materials include, but are not limited to, stainless steel, nickel-titanium, or any number of plastics, composites, shape memory alloys, and the like. Persons of ordinary skill will recognize that conventional instrument-making techniques may generally be applied to the manufacture of instruments 10 according to the invention and with various known or later-developed materials and/or methods. For example, the facets 40, 42, 44, 46, 48, 50, 52 and 54 of the instruments 10 of the invention may be formed by multi-pass grinding or milling and the flutes 26, 28 and 30 may be formed by broaching or saw cutting.

FIGS. 5A-G depict alternative embodiments of the invention in which, among other features, the number and shape of the facets and the number and shape of the flutes are varied. In each individual embodiment, the void area bounded by the intervening facets and concave surfaces between adjacent pairs of guiding and cutting edges at the maximum radius, and the imaginary circle 43, is less than half of the total area of the imaginary circle 43.

With reference to FIG. 5A in which like reference numerals refer to like features in FIG. 3 and in accordance with an alternative embodiment of the invention, the working length 16 of an endodontic instrument 10a is provided with a guiding edge 64 and a pair of flutes 66 and 68 each having a corresponding continuously-curved concave surface 66a and 68a defining cutting edges 71 and 70, respectively, each having a positive rake angle. Viewed parallel to the axis 17, the endodontic instrument 10a has a generally triangular cross-sectional profile. The cutting edges 70 and 71 are defined at the former locations of guiding edges, as described above. Instrument 10a includes facets 72, 74 and 76, of which the transverse width of facets 72 and 74 are shortened by the presence of flutes 66 and 68, respectively. Guiding edge 64 is defined at the intersection of shortened-width facet 74 and full-width facet 76. Neglecting the presence of the flutes 66 and 68, the facets 72, 74 and 76 are substantially equal in width, are slightly convex and inscribed within the imaginary circle 43, and have mirror symmetry in cross-section about three orthogonal planes. The dimensions and characteristics of flutes 66 and 68 may or may not be substantially equal.

With reference to FIG. 5B in which like reference numerals refer to like features in FIG. 3 and in accordance with an alternative embodiment of the invention, the working length 16 of an endodontic instrument 10b is provided with two guiding edges 80 and 82 and two cutting edges 84 and 86 each defined by one of a pair of flutes 88 and 90, respectively, each having a concave surface 88a and 90a formed from two intersecting planar surfaces. Viewed parallel to the axis 17, the endodontic instrument 10b has a cross-sectional profile generally shaped as a square. The invention contemplates that the cross-sectional profile of endodontic instrument 10b may be any quadrilateral without limitation. Cutting edge 84 is characterized by a neutral rake angle, while cutting edge 86 is characterized by a negative rake angle. The flute depths, flute volumes, and cross-sectional profiles viewed parallel to the shaft axis 17 differ for the flutes 88 and 90. Neglecting the presence of the flutes 88 and 90, the facets 92, 94, 96 and 98 are substantially equal in width, have a slight concave curvature, and have mirror symmetry in cross-section about four orthogonal planes.

With reference to FIG. 5C in which like reference numerals refer to like features in FIG. 3 and in accordance with an alternative embodiment of the invention, the working length 16 of an endodontic instrument 10c is provided with one cutting edge 100 defined by a flute 102 having a concave surface 102a constructed from one planar surface and one continuously curved surface and four guiding edges 104, 106, 108 and 110. The rake angle of the cutting edge 100 is neutral. Viewed parallel to the axis 17, the endodontic instrument 10c has a generally pentagonal cross-sectional profile. Neglecting the presence of the flute 102, facets 112, 114, 116, 118 and 120 differ in width and lack mirror symmetry. Facets 112, 116 and 120 are slightly concave, facet 118 is slightly convex, and facet 114 is substantially planar.

With reference to FIG. 5D in which like reference numerals refer to like features in FIG. 3 and in accordance with an alternative embodiment of the invention, the working length 16 of an instrument 10d is provided with three rounded guiding edges 122, 124, and 126 and two cutting edges 128 and 130 each defined by one of a pair of flutes 132 and 134. Cutting edge 128 has a positive rake angle and cutting edge 130 has a negative rake angle. Viewed parallel to the axis 17, the endodontic instrument 10d has a generally hexagonal cross-sectional profile. The flute depths, flute volumes, and cross-sectional profiles viewed parallel to the shaft axis 17 differ for the flutes 132 and 134. Flute 132 is formed from a concave surface 132a constructed from two planar surfaces and a continuously curved surface and, in contrast, flute 134 has a concave surface 134a constructed from two continuously-curved surfaces and three planar surfaces. Neglecting the presence of the flutes 132 and 134, facets 136, 138, 140, 142, 144 and 146 are substantially equal in width and have mirror symmetry in cross-section about six orthogonal planes.

With reference to FIG. 5E in which like reference numerals refer to like features in FIG. 3 and in accordance with an alternative embodiment of the invention, the working length 16 of an endodontic instrument 10e is provided with five cutting edges 148, 150, 152, 154 and 156 each defined by one of five flutes 158, 160, 162, 164 and 166 and two guiding edges 168 and 170. Cutting edges 148 and 150 have a positive rake angle, cutting edge 154 has a neutral rake angle, and cutting edges 152 and 156 have a negative rake angle. Viewed parallel to the axis 17, the endodontic instrument 10e has a generally heptagonal cross-sectional profile. The flute depths, flute volumes, and cross-sectional profiles viewed parallel to the shaft axis 17 differ among the flutes 158, 160, 162, 164 and 166. Flute 158 is constructed with a continuously-curved concave surface 158a. Flute 160 has a concave surface 160a constructed from one continuously curved surface and one planar surface. Flutes 162 and 166 are each formed from two intersecting planar surfaces. Flute 164 is formed from multiple continuously curved surfaces and planar surfaces. Neglecting the presence of the flutes 158, 160, 162, 164 and 166, facets 172, 174, 176, 178, 180, 182 and 184 differ in width, are substantially-planar, and lack mirror symmetry in any orthogonal plane.

With reference to FIG. 5F in which like reference numerals refer to like features in FIG. 3 and in accordance with an alternative embodiment of the invention, the working length 16 of an endodontic instrument 10f is provided with a guiding edge 350 and a flute 352 having a corresponding continuously-curved concave surface 352a defining cutting edge 354 with a positive rake angle. Viewed parallel to the axis 17, the endodontic instrument 10f has a generally ovoidal cross-sectional profile. The cutting edge 354 is defined at the former location of a guiding edge, as described above. Curved surface 356 is divided by flute 352. Curved surfaces 358 and 356 are connected on one side by planar surface 360 to define one region of the cross-section, and on the other side by curved surface 362 which, when combined with the remaining section of curved surface 356 and flute surface 352a, define another region of the cross-section. Guiding edge 350 is defined by the point on curved surface 358 that is most distant from the axis 17. Curved surfaces 358, 356 and 362 are substantially unequal, however, the invention contemplates that two or all of these curves may be substantially equal. Neglecting the presence of the flute 352, each curved surface 356 and 358 makes contact with the imaginary circle 43 at a single point. The cross-section shown in FIG. 5F lacks mirror symmetry in any orthogonal plane.

With reference to FIG. 5G in which like reference numerals refer to like features in FIG. 3 and in accordance with an alternative embodiment of the invention, the working length 16 of an endodontic instrument 10g is provided with two guiding edges 370 and 372 and a flute 374 having a corresponding continuously-curved concave surface 374a defining cutting edge 376 with a positive rake angle. Viewed parallel to the axis 17, the endodontic instrument 10g has a generally modified ovoidal cross-sectional profile. The cutting edge 376 is defined at the former location of a guiding edge, as described above. Curved surface 378 is divided by flute 374. Instrument 10g includes curved surfaces 378, 380, 382, 384, 386, 388, 390 and 392, which are all connected. A section of each of curved surfaces 378 and 382 are connected by curved surfaces 380 and 388 to define one region. Likewise, a section of each of curved surfaces 382 and 386 are connected by curved surfaces 384 and 390 to define another region. The remaining sections of curved surfaces 378 and 386 combine with curved surface 392 and flute surface 374a to define the final region of the cross-section. Guiding edges 370 and 372 are defined by the points on curved surfaces 382 and 386, respectively, that are most distant from the axis 17. Curved surfaces 378 and 386 are substantially equal, curved surfaces 380 and 384 are substantially equal, and curved surfaces 388, 390, and 392 are substantially equal, however, each specified group differs from the others and they all differ from curved surface 382. Neglecting the presence of the flute 374, each curved surface 378, 382 and 386 makes contact with the imaginary circle 43 at a single point. Guiding edges 370 and 372, and cutting edge 376 are spaced about the circumference of the working length 16 at unequal angular intervals α″, β″, and θ″ and therefore the cross-section shown in FIG. 5G lacks mirror symmetry in any orthogonal plane.

The number of flutes and, hence, the number of cutting edges may be modified among the various embodiments of the invention depicted in FIGS. 5A-G, so long as at least one guiding edge with a rake angle more negative than about −30° is retained. The facets and curved surfaces only contact the root canal wall by way of a guiding edge. Therefore, the only portions of the instrument 10 contacting the root canal wall will be the cutting edges and the guiding edges, as the instrument 10 lacks lands.

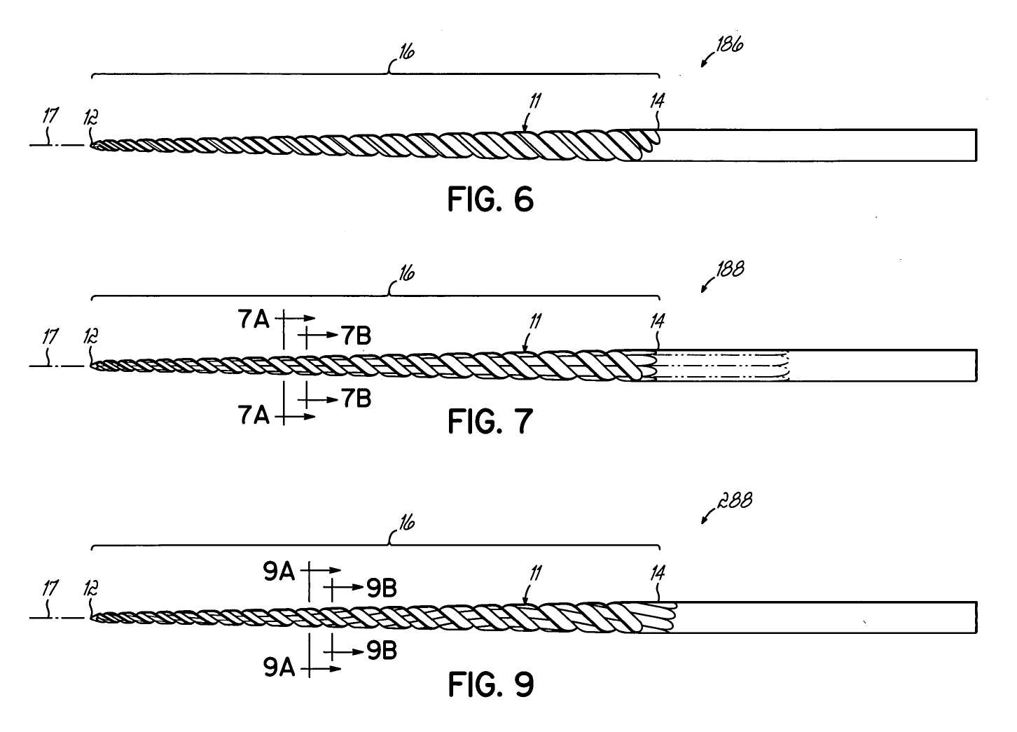

It is appreciated that instrument 10 may be used as a reamer or a file for extirpation when rotated in a counterclockwise sense as viewed along the shaft axis 17 from the perspective of FIG. 3, FIG. 4B and FIGS. 5A-G. Instrument 10 may be configured with negative helix fluting that is a mirror image of FIGS. 6, 7 and 9 for use as a condenser for pushing obturation materials, such as gutta percha, toward the canal apex to fill an extirpated root canal.

With reference to FIG. 6 in which like reference numerals refer to like features in FIGS. 1-4 and in accordance with an alternative embodiment, an endodontic instrument 186 may be formed from instrument 10 by twisting the working length 16 so that the facets 40, 42, 46, 48 and 52 and flutes 26, 28 and 30 bear a helical or spiral relationship characterized by a pitch. The pitch of helical facets and flutes may be constant or may vary, as understood by persons of ordinary skill in the art. The instrument 186 may be manufactured by creating straight axial facets and flutes, as depicted in FIG. 1, and then twisting, as understood by persons of ordinary skill in the art, the instrument 10 to twist the facets 40, 42, 46, 48 and 52 and flutes 26, 28 and 30 into a helical or spiral configuration. Techniques for manufacturing twisted endodontic instruments are disclosed in commonly-assigned U.S. Pat. No. 6,315,558, the disclosure of which is hereby incorporated by reference herein in its entirety. Subsequent to twisting, the cross-sectional profile of the endodontic instrument 186 will be substantially identical to the cross-sectional profile of endodontic instrument 10 (FIG. 3) at any axial position along the working length 16. Alternatively, one or both of the facets 40, 42, 46, 48 and 52 and/or flutes 26, 28 and 30 may be formed as post-twisting features. For example, flutes 26, 28 and 30 may be formed before shaft 11 is twisted and the facets 40, 42, 46, 48 and 52 may be formed after twisting. The invention contemplates that, in alternative embodiments, the endodontic instrument 186 may have a construction based upon any of the cross-sectional profiles shown in FIGS. 5A-5G.

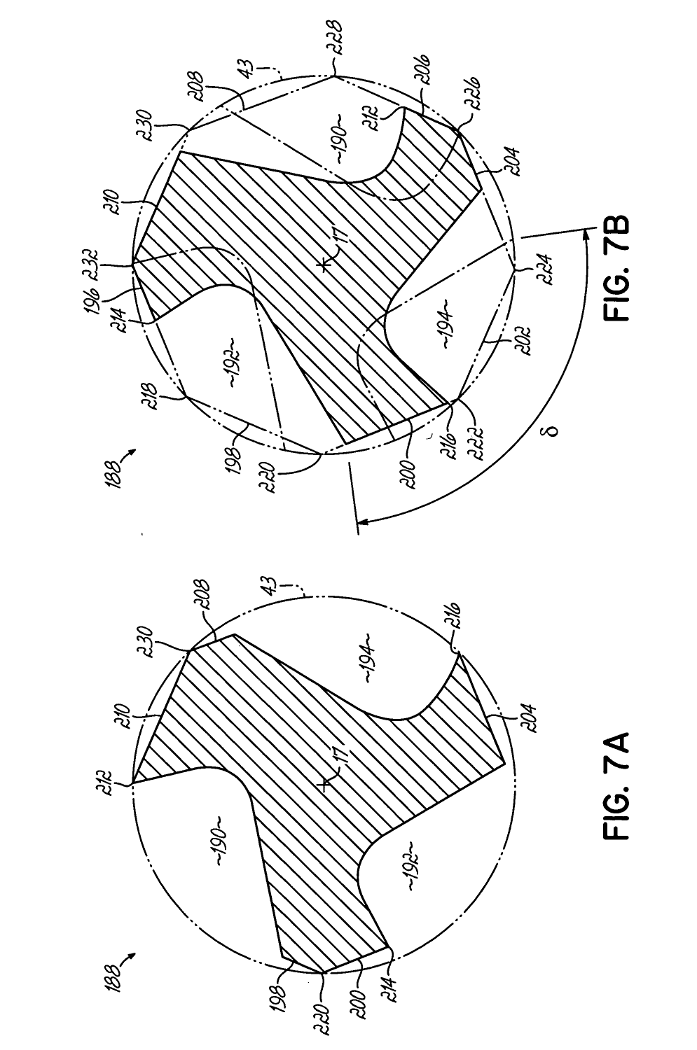

With reference to FIGS. 7, 7A and 7B in which like reference numerals refer to like features in FIGS. 1-4 and 6 and in accordance with an alternative embodiment, an endodontic instrument 188 includes a plurality of lengthwise-extending flutes 190, 192 and 194, similar to flutes 26, 28 and 30 (FIGS. 1-3), and a plurality of facets 196, 198, 200, 202, 204, 206, 208 and 210, similar to facets 40, 42, 44, 46, 48, 50, 52 and 54 (FIGS. 1-4). Each of the flutes 190, 192 and 194 defines one of a corresponding plurality of cutting edges 212, 214, and 216, similar to cutting edges 20, 22 and 24 (FIGS. 1-3). Extending along axis 17 is a plurality of guiding edges 218, 220, 222, 224, 226, 228, 230 and 232, similar to guiding edges 32, 34, 56, 58, 60, 62, 64 and 66 (FIG. 4B), each defined at the intersection of coextensive adjacent facets 196, 198, 200, 202, 204, 206, 208 and 210. The invention contemplates that, in alternative embodiments, the endodontic instrument 188 may have a construction based upon any of the cross-sectional profiles shown in FIGS. 5A-5G.

The facets 196, 198, 200, 202, 204, 206, 208 and 210 and, hence, guiding edges 218, 220, 222, 224, 226, 228, 230 and 232 have a constant zero-degree helix angle and, hence, a constant pitch. As is best apparent in FIG. 7, the flutes 190, 192 and 194 and, hence, cutting edges 212, 214, and 216 wind about the working length 16 with a spiral or helical arrangement that varies in helix angle and pitch axially along the working length 16 of endodontic instrument 188. The facets 196, 198, 200, 202, 204, 206, 208 and 210 extend linearly along the working length 16 and are periodically interrupted by the flutes 190, 192 and 194 winding about the working length 16. This leads to discontinuities in the guiding edges 218, 220, 222, 224, 226, 228, 230 and 232. At any axial location along the working length 16, a specific combination of guiding edges 218, 220, 222, 224, 226, 228, 230 and 232 dependent upon the angular orientation of the flutes 190, 192 and 194 is manifested in the cross-sectional profile of the working length 16.

The cross-sectional profile of the endodontic instrument 188 exhibits a dependence upon axial location along the working length 16 because of the different helix angles of flutes 190, 192 and 194 and facets 196, 198, 200, 202, 204, 206, 208 and 210. At a first axial location shown in FIG. 7A, the cross-sectional profile of the endodontic instrument 188 has an appearance similar to that of FIG. 3. Guiding edges 220 and 230 are observed in the cross-sectional profile for this angular orientation of the flutes 190, 192 and 194. At a second location shown in FIG. 7B, the flutes 190, 192 and 194 have effectively rotated about axis 17 through an angle, δ. Guiding edges 226 and 232 are observed in the cross-sectional profile for this angular orientation of the flutes 190, 192 and 194. At any arbitrary axial location along the working length 16, however, the cutting edges 212, 214 and 216 and the specific guiding edges 218, 220, 222, 224, 226, 228, 230 and 232 present at each axial location are subject to the requirement of being either on or inside the imaginary circle 43. The various cross-sectional profiles of the endodontic instrument 188 may repeat along the working length 16.

With specific reference to FIG. 7 and in an alternative embodiment, the facets 196, 198, 200, 202, 204, 206, 208 and 210 of endodontic instrument 188 may optionally extend up shaft 11 for a greater distance in a direction toward distal end 14 than flutes 190, 192 and 194. Over this distance, the cutting edges 212, 214 and 216 are absent and only guiding edges 218, 220, 222, 224, 226, 228, 230 and 232 are present, as indicated by the dot-dashed lines in FIG. 7. The extent over which the facets 196, 198, 200, 202, 204, 206, 208 and 210 extend up shaft 11 may be less than the distance illustrated in FIG. 7 or greater than the distance illustrated in FIG. 7. In certain specific embodiments, the facets 196, 198, 200, 202, 204, 206, 208 and 210 of endodontic instrument 188 may extend the entire length of shaft 11.

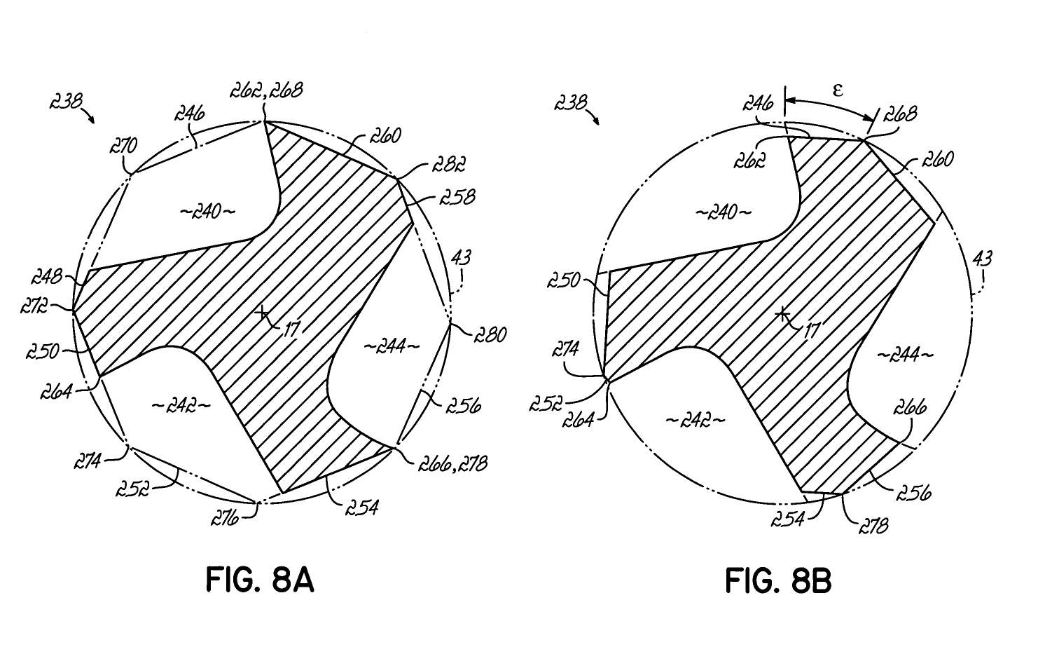

With reference to FIGS. 8A and 8B in which like reference numerals refer to like features in FIGS. 1-4 and 6 and in accordance with an alternative embodiment, an endodontic instrument 238 includes a plurality of lengthwise-extending flutes 240, 242 and 244, similar to flutes 26, 28 and 30 (FIGS. 1-3), and a plurality of facets 246, 248, 250, 252, 254, 256, 258 and 260, similar to facets 40, 42, 44, 46, 48, 50, 52 and 54 (FIGS. 1-4). Each of the flutes 240, 242 and 244 defines one of a corresponding plurality of cutting edges 262, 264 and 266, similar to cutting edges 20, 22 and 24 (FIGS. 1-3). Extending along axis 17 is a plurality of guiding edges 268, 270, 272, 274, 276, 278, 280 and 282, similar to guiding edges 32, 34, 56, 58, 60, 62, 64 and 66 (FIG. 4B), each defined at the intersection of coextensive adjacent facets 246, 248, 250, 252, 254, 256, 258 and 260. Of the guiding edges, it is appreciated that edges 268 and 278 are transformed by the flutes 240 and 244 into cutting edges 262 and 266, respectively, and may be observed as features in cross-sectional profiles taken at other axial locations along the working length 16. The invention contemplates that, in alternative embodiments, the endodontic instrument 238 may have a construction based upon any of the cross-sectional profiles shown in FIGS. 5A-5G.

Flutes 240, 242 and 244 and, hence, cutting edges 262, 264 and 266 have a constant zero-degree helix angle and, hence, a constant pitch. Facets 246, 248, 250, 252, 254, 256, 258 and 260 and, hence, guiding edges 268, 270, 272, 274, 276, 278, 280 and 282 wind about the working length 16 with a spiral or helical arrangement that varies in helix angle and pitch axially along the working length 16 of endodontic instrument 188. The flutes 240, 242 and 244 extend linearly along the working length 16 and are continuously altered by the facets 246, 248, 250, 252, 254, 256, 258 and 260 winding about the working length 16. At any axial location along the working length 16, a specific combination of guiding edges 268, 270, 272, 274, 276, 278, 280 and 282 dependent upon the angular orientation of the facets 246, 248, 250, 252, 254, 256, 258 and 260 is manifested in the cross-sectional profile of the working length 16.

The cross-sectional profile of the endodontic instrument 238 exhibits a dependence upon axial location along the working length 16 because of the different helix angles of flutes 240, 242 and 244, and facets 246, 248, 250, 252, 254, 256, 258 and 260. At a first axial location shown in FIG. 8A, the cross-sectional profile of the endodontic instrument 238 has an appearance similar to that of FIG. 3. Guiding edges 272 and 282 are observed in the cross-sectional profile for this angular orientation of the facets 246, 248, 250, 252, 254, 256, 258 and 260 as flutes 240, 242 and 244 have eliminated the other guiding edges. At a second location shown in FIG. 8B, the facets 246, 248, 250, 252, 254, 256, 258 and 260 have effectively rotated about axis 17 through an angle, E. Guiding edges 268, 274 and 278 are observed in the cross-sectional profile for this angular orientation of the facets 246, 248, 250, 252, 254, 256, 258 and 260 as the other guiding edges are not present at this axial location. At any arbitrary axial location along the working length 16, however, the cutting edges 262, 264 and 266 and the specific guiding edges 268, 270, 272, 274, 276, 278, 280 and 282 present at each axial location are subject to the requirement of being either on or inside the imaginary circle 43.

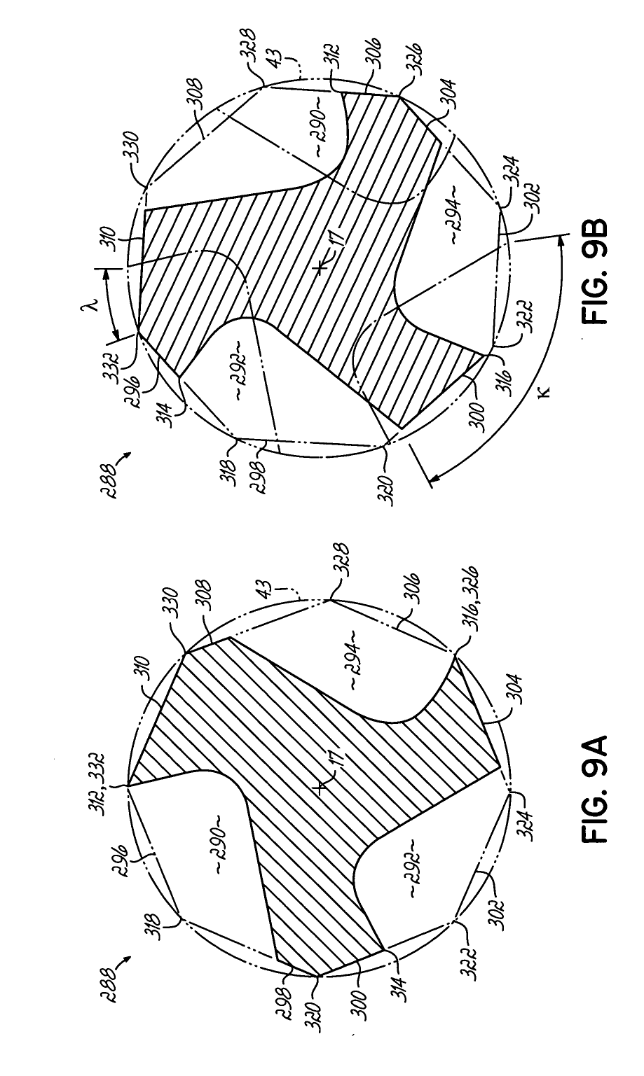

With reference to FIGS. 9, 9A and 9B in which like reference numerals refer to like features in FIGS. 1-4 and 6 and in accordance with an alternative embodiment, an endodontic instrument 288 includes a plurality of lengthwise-extending flutes 290, 292 and 294, similar to flutes 26, 28 and 30 (FIGS. 1-3), and a plurality of facets 296, 298, 300, 302, 304, 306, 308 and 310, similar to facets 40, 42, 44, 46, 48, 50, 52 and 54 (FIGS. 1-4). Each of the flutes 290, 292 and 294 defines one of a corresponding plurality of cutting edges 312, 314 and 316, similar to cutting edges 20, 22 and 24 (FIGS. 1-3). Extending along axis 17 is a plurality of guiding edges 318, 320, 322, 324, 326, 328, 330 and 332, similar to guiding edges 32, 34, 56, 58, 60, 62, 64 and 66 (FIG. 4B), each defined at the intersection of coextensive adjacent facets 296, 298, 300, 302, 304, 306, 308 and 310. The invention contemplates that, in alternative embodiments, the endodontic instrument 288 may have a construction based upon any of the cross-sectional profiles shown in FIGS. 5A-5G.

The facets 296, 298, 300, 302, 304, 306, 308 and 310 and, hence, guiding edges 318, 320, 322, 324, 326, 328, 330 and 332 are characterized by a first helix angle and pitch. As is best apparent in FIG. 9, the flutes 290, 292 and 294 and, hence, cutting edges 312, 314, and 316 wind about the working length 16 with a spiral or helical arrangement that varies in helix angle and pitch axially along the working length 16 of endodontic instrument 288. The facets 296, 298, 300, 302, 304, 306, 308 and 310 are characterized by a second helix angle and pitch that differs from the first helix angle and pitch of the facets 296, 298, 300, 302, 304, 306, 308 and 310. As is again best apparent in FIG. 9, the facets 296, 298, 300, 302, 304, 306, 308 and 310 wind about the working length 16 with a spiral or helical arrangement that varies in helix angle and pitch axially along the working length 16 of endodontic instrument 288. In particular, the helix angle of the facets 296, 298, 300, 302, 304, 306, 308 and 310 is positive over sections of working length 16 near each of the ends 12 and 14 and is negative near the center section of the working length 16. At any axial location along the working length 16, a specific combination of guiding edges 318, 320, 322, 324, 326, 328, 330 and 332 dependent upon the relative angular orientations of the flutes 290, 292 and 294 and the facets 296, 298, 300, 302, 304, 306, 308 and 310 is manifested in the cross-sectional profile of the working length 16.

The cross-sectional profile of the endodontic instrument 288 exhibits a dependence upon axial location along the working length 16 because of the variable helix angle and pitch of flutes 290, 292 and 294 and of facets 296, 298, 300, 302, 304, 306, 308 and 310. At a first axial location shown in FIG. 9A, the cross-sectional profile of the endodontic instrument 288 has an appearance similar to that of FIG. 3. Guiding edges 320 and 330 are observed in the cross-sectional profile for this angular orientation of the flutes 290, 292 and 294. At a second location shown in FIG. 9B, the flutes 290, 292 and 294 have effectively rotated about axis 17 through an angle, κ, and facets 296, 298, 300, 302, 304, 306, 308 and 310 have rotated through an angle, λ. Guiding edges 326 and 332 are observed in the cross-sectional profile for this angular orientation of the flutes 290, 292 and 294. At any arbitrary axial location along the working length 16, however, the cutting edges 312, 314 and 316 and the specific guiding edges 318, 320, 322, 324, 326, 328, 330 and 332 present at each axial location are subject to the requirement of being either on or inside the imaginary circle 43. The various cross-sectional profiles of the endodontic instrument 288 may repeat along the working length 16.

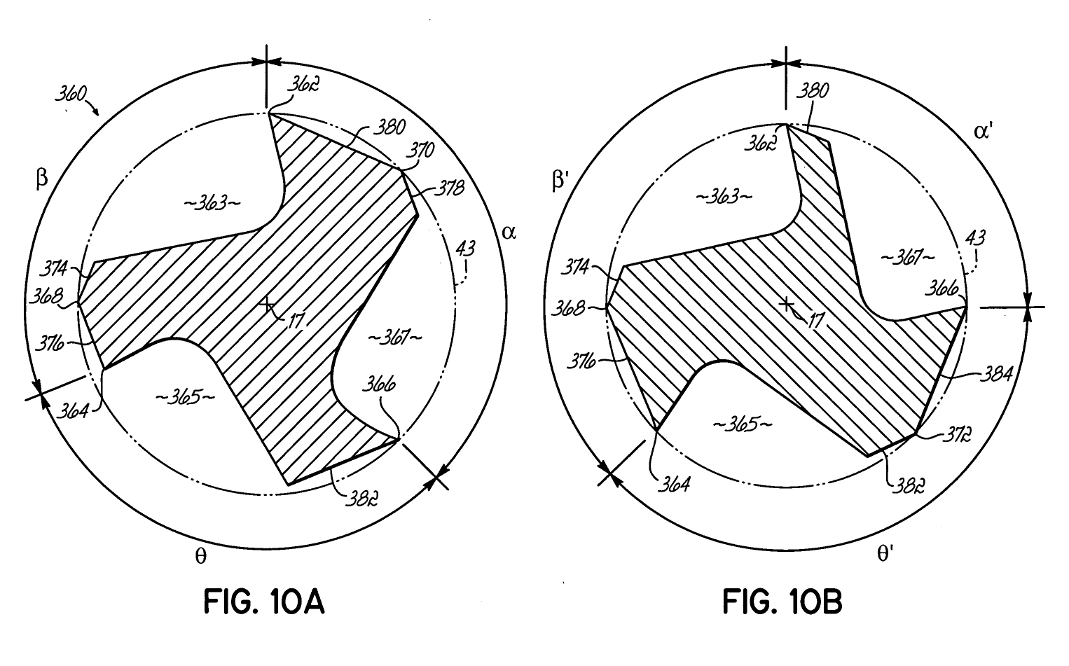

With reference to FIGS. 10A and 10B in which like reference numerals refer to like features in FIGS. 1-4 and 6 and in accordance with an alternative embodiment, an endodontic instrument 360 includes cutting edges 362, 364 and 366 defined by flutes 363, 365 and 367 and multiple guiding edges, of which guiding edges 368 and 370 are visible in FIG. 10A at a first axial location along the working length 16 and guiding edges 368 and 372 are visible in FIG. 10B at a second axial location along the working length. Other guiding edges (not shown) may be visible in the cross-sectional profile at different locations along the working length 16 of endodontic instrument 360. Guiding edge 368 is defined at the intersection of facets 374 and 376, guiding edge 370 is defined at the intersection of facets 378 and 380, and guiding edge 372 is defined at the intersection of facets 382 and 384.

The cutting edges 362, 364 and 366 are spaced about the circumference of the working length 16 at unequal angular intervals, in which the specific angular intervals are dependent upon the axial location at which the cross-sectional profile is taken along the working length 16. At one representative location along the working length 16 shown in FIG. 10A, the cutting edges 362, 364 and 366 are separated by angular intervals of α, β, and θ. At a different representative location defined along the working length 16 as shown in FIG. 10B, the cutting edges 362, 364 and 366 are separated by angular intervals of α′, β′, and θ′ that differ from α, β, and θ. These angular intervals are understood to assume an arbitrary number of values along the working length 16. The angular variation in the circumferential location of the cutting edges 362, 364 and 366 results from non-parallel flutes 363, 365 and 367 formed in the working length 16. The invention contemplates that, in alternative embodiments, the endodontic instrument 360 may have a construction based upon any of the cross-sectional profiles shown in FIGS. 5A-5G.

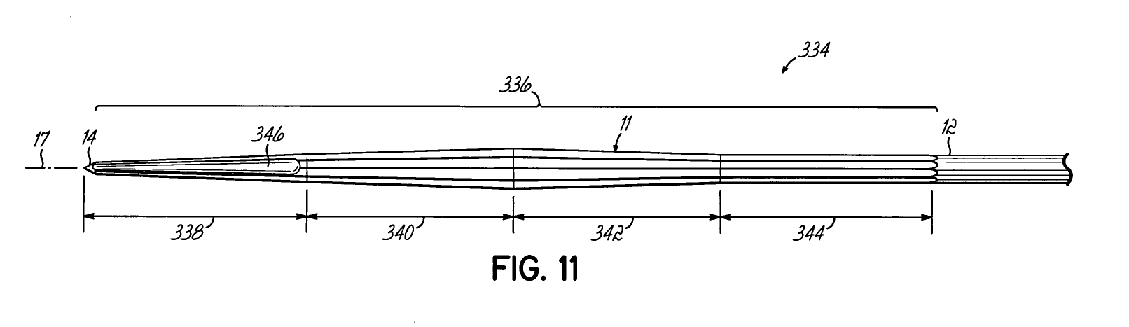

With reference to FIG. 11, an endodontic instrument 334 includes a working length 336 that has multiple tapered sections 338, 340 and 342 and a zero taper section 344, respectively, between ends 12 and 14. Tapered section 338 has a positive taper and is contiguous with tapered section 340, tapered section 340 has a less positive taper and is contiguous with tapered section 342, and tapered section 342 has a negative taper and is contiguous with zero taper section 344, although the invention is not so limited. Tapered section 338 incorporates a plurality of flutes arranged about the circumference of the working length 336, of which only flute 346 is visible. By way of example and not by way of limitation, tapered section 338 may be given a taper of about 0.1 mm/mm, tapered section 340 may have a taper of about 0.03 mm/mm, tapered section 342 may have a taper of −0.04 mm/mm. In various different embodiments, section 338 may have any of the geometric arrangements previously described herein, and sections 340, 342 and 344 may include only facets and curved surfaces in any combination based upon any of the geometric arrangements previously described herein.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. For example, the instruments of the invention may be utilized for non-dental applications such as preparing bone, which has a soft internal cancellous tissue surrounded by an outer compact/cortical tissue, for implants, or in plastic surgery. The invention in its broader aspects is therefore not limited to the specific details, representative apparatus and methods, and illustrative examples shown and described. Accordingly, departures may be made from such details without departing from the spirit or scope of the applicant's general inventive concept.

1. An apparatus comprising:
an elongated shaft having a longitudinal axis, a working length extending along said longitudinal axis, and a plurality of longitudinal regions arranged about said longitudinal axis; and
a plurality of edges extending longitudinally along said working length and each distanced radially from said longitudinal axis, adjacent pairs of said plurality of edges adjoined by a corresponding one of said plurality of regions, at least one of said plurality of edges having a rake angle more negative than about −30°, at least one of said plurality of edges having a rake angle equal to or more positive than 0°, and each of said plurality of edges defining a maximum radius measured at said axial location perpendicular to said longitudinal axis,
wherein said plurality of regions are positioned radially inside an imaginary circle centered about said longitudinal axis at any axial location along the working length at which a cross-section may be taken perpendicular to the longitudinal axis, said imaginary circle has a radius measured perpendicular to said longitudinal axis equal to said maximum radius, and said plurality of edges are arranged such that each void area bounded by each of said plurality of regions and said imaginary circle is less than half the total area of said imaginary circle.

2. The apparatus of claim 1 wherein said rake angle of at least two edges from among said plurality of edges is equal to or more positive than 0°.

3. The apparatus of claim 2 wherein said at least two edges have equal rake angles.

4. The apparatus of claim 2 wherein said rake angle of said at least two edges is positive.

5. The apparatus of claim 4 wherein said at least two edges have equal rake angles.

6. The apparatus of claim 2 wherein said rake angle of said at least two edges is equal to 0°.

7. The apparatus of claim 2 further comprising:
a plurality of flutes each extending longitudinally along said working length, each of said at least two edges defined by an intersection between a corresponding one of said plurality of flutes and one of said plurality of regions.

8. The apparatus of claim 2 wherein said at least two edges are characterized by an unequal circumferential angular spacing about said working length.

9. The apparatus of claim 8 wherein said unequal angular spacing varies as a function of axial location along said working length.

10. The apparatus of claim 1 wherein said rake angle of at least two of said plurality of edges is less than about −30°.

11. The apparatus of claim 10 wherein said at least two edges have equal rake angles.

12. The apparatus of claim 1 wherein at least one of said plurality of edges has a rake angle more negative than 0° and more positive than about −30°.

13. The apparatus of claim 1 wherein at least one of said plurality of edges is rounded.

14. The apparatus of claim 1 wherein each of said plurality of edges extends substantially straight along said longitudinal axis.

15. The apparatus of claim 1 wherein said plurality of edges are wound helically about said longitudinal axis.

16. The apparatus of claim 1 wherein said at least one of said plurality of edges having a rake angle more negative than about −30° extends substantially straight along said longitudinal axis and said at least one of said plurality of edges having a rake angle equal to or more positive than 0° is wound helically about said longitudinal axis.

17. The apparatus of claim 1 wherein said at least one of said plurality of edges having a rake angle more negative than about −30° is wound helically about said longitudinal axis and said at least one of said plurality of edges having a rake angle equal to or more positive than 0° extends substantially straight along said longitudinal axis.

18. The apparatus of claim 1 wherein said at least one of said plurality of edges having a rake angle more negative than about −30° is wound helically about said longitudinal axis and said at least one of said plurality of edges having a rake angle equal to or more positive than 0° is wound helically about said longitudinal axis, each characterized by a different pitch.

19. The apparatus of claim 1 wherein said at least one of said plurality of edges having a rake angle equal to or more positive than 0° is wound helically about said longitudinal axis and is characterized by a variable pitch.

20. The apparatus of claim 1 wherein said at least one of said plurality of edges having a rake angle equal to or more positive than 0° extends along a first portion of said working length.

21. The apparatus of claim 20 wherein said at least one of said plurality of edges having a rake angle more negative than about −30° extends along the full working length.

22. The apparatus of claim 21 wherein said working length includes a plurality of sections each having a taper.

23. A method of making an instrument from a workpiece with a longitudinal axis, comprising:
forming a plurality of longitudinally-extending surfaces arranged circumferentially about the workpiece, each pair of adjacent surfaces meeting at a corresponding one of a plurality of first edges characterized by a rake angle more negative than about −30° and the workpiece free of lands after the longitudinally-extending surfaces are formed; and
forming one or more flutes in the workpiece, each of the flutes defining a second edge characterized by a rake angle equal to or more positive than 0°.

24. The method of claim 23 wherein, before forming the one or more flutes, the workpiece has a substantially polygonal cross-sectional profile viewed parallel to the longitudinal axis.

25. The method of claim 23 wherein said workpiece has a cross-sectional profile selected from the group consisting of triangular, quadrilateral, pentagonal, hexagonal, heptagonal, and octagonal.

26. The method of claim 23 wherein the one or more flutes are is formed concurrently with the plurality of longitudinally-extending surfaces.

27. The method of claim 23 wherein the one or more flutes are formed after the plurality of longitudinally-extending surfaces are formed.

28. The method of claim 23 wherein the one or more flutes are formed before the plurality of longitudinally-extending surfaces are formed.

29. The method of claim 23 wherein each of said longitudinally-extending surfaces includes at least one curve when viewed in cross section parallel to the longitudinal axis.

30. The method of claim 29 wherein, before forming the one or more flutes, the workpiece has a substantially ovoidal cross-sectional profile viewed parallel to the longitudinal axis.

31. The method of claim 30 wherein said workpiece has a modified ovoidal cross-sectional profile viewed parallel to the longitudinal axis resulting in three or more first and second edges.
